(19) United States
(12) Patent Application Publication
(10) Pub. No.: US 2020/0219329 A1
(43) Pub. Date: Jul. 9, 2020

(54) MULTI AXIS TRANSLATION

(71) Applicant: Intuitive Research and Technology Corporation, Huntsville, AL (US)

(72) Inventors: Chanler Crowe, Madison, AL (US); Michael Jones, Athens, AL (US); Kyle Russell, Huntsville, AL (US); Michael Yohe, Meridianville, AL (US)

(21) Appl. No.: 16/680,823

(22) Filed: Nov. 12, 2019

Related U.S. Application Data
(60) Provisional application No. 62/790,333, filed on Jan. 9, 2019.

(51) Int. Cl. G06T 19/20; G06T 17/20

(52) U.S. Cl. CPC G06T 19/20; G06T 17/20; G06T 2219/2016; G06T 2210/41; G06T 2219/2004; G06T 2219/008; G06T 2200/24

(57) ABSTRACT

A system and method for translating information from two-dimensional images into three-dimensional images allows a user to adjust the two-dimensional images when they are imported in three-dimensions. The user may realign misaligned image sets and align images to any user-determined arbitrary plane. In the method, a series of two-dimensional images is imported, and a pixel location is read for each pixel in each image. Meshes are spawned representing each individual pixel. The images are rendered and three-dimensional models are exported, the models capable of arbitrary manipulation by the user.

### REFERENCE TO RELATED APPLICATIONS

This application claims priority to Provisional Patent Application U.S. Ser. No. 62/790,333, entitled “Multi Axis Translation” and filed on Jan. 9, 2019, which is fully incorporated herein by reference.

### BACKGROUND AND SUMMARY

Some methods of imaging, such as medical imaging, provide images of horizontal or vertical slices of the interior of the human body. There are many medical imaging systems used to acquire medical images suitable for diagnosis of disease or injury, such as: X-ray, CT scans, Mill, ultrasound, and nuclear medicine systems. These systems can produce large amounts of patient data, which are generally in the format of a series of continuous two-dimensional slices of images. These images are used for diagnostic interpretation by physicians viewing potentially hundreds of images to locate the cause of the disease or injury.

There are existing systems and software capable of converting the two-dimensional images to three-dimensional models. However, this software limits the translation to alignment to three specified axes. These axes are the coronal, sagittal, and axial planes. The coronal plane divides the body into front and back sections, i.e., goes through the middle of the body between the body's front and back halves. The sagittal plane divides the body into left and right halves, i.e., goes through the middle of the body between the body's left and right halves. The axial plane is parallel to the ground and divides the body into top and bottom parts.

These planes are like traditional x, y, and z axes, but these planes are oriented in relation to the person being scanned. Importantly, with the traditional systems, the user is unable to choose another plane to translate the image. Further, it is common for patients to be imperfectly aligned during imaging, so the 3D models generated from the misaligned images are often distorted.

What is needed is a system and method to improve diagnostic process, workflow, and precision through advanced user-interface technologies in a virtual reality environment. The system and method according to the present disclosure allows the user to upload two-dimensional images, which may be easily converted to a three-dimensional mesh. This three-dimensional mesh enables the user to translate the image into any arbitrary plane.

The system and method according to the present disclosure allows for the selection and manipulation of the axes of the created three-dimensional model. Under the disclosed system and method, the user uploads images. The method uses the images to create a three-dimensional model of the image. The disclosed system and method allows the user to select a plane when rendering a new set of images.

In one embodiment, the method would use medical Digital Imaging and Communications in Medicine (DICOM) images to convert two-dimensional images to two-dimensional image textures, which are capable of manipulation. The method then uses the two-dimensional image textures to create the images to generate a three-dimensional image based upon the two-dimensional image pixels. The method evaluates the pixels in a series of two-dimensional images before recreating the data in three-dimensional space. The program maintains the location of each pixel relative to its location in the original medical imagery by utilizing the height between the images. The program uses the image spacing commonly provided by medical imagery or specified spacing variables to determine these virtual representations. Once this is determined, the user can select a new plane or direction to render the images. The system will allow keyboard input, use of a mouse, manipulation of a virtual plane in the image set in virtual reality, or any other type of user input. Once the new direction or plane is set, the program renders a new set of images in the specified plane at specified intervals.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 depicts a system for creating three-dimensional models capable of arbitrary manipulation on multiple axes according to an exemplary embodiment of the present disclosure.

FIG. 2 illustrates the relationship between three-dimensional assets, the data representing those assets, and the communication between that data and the software, which leads to the representation on the XR platform.

FIG. 3 depicts a method of data importation and manipulation performed by the system, according to an exemplary embodiment of the present disclosure.

FIG. 4 depicts a method for creating three-dimensional models capable of unlimited manipulation on arbitrary axes, according to an exemplary embodiment of the present disclosure.

FIG. 5 depicts a method of rendering images according to an exemplary embodiment of the present disclosure.

FIG. 6 depicts a virtual camera capturing a two-dimensional image of a plane.

FIG. 7 depicts a virtual camera capturing a two-dimensional image of a multi-axis translation plane with other planes above the multi-axis translation plane awaiting capture.

FIG. 8 depicts a virtual camera capturing a two-dimensional image of a multi-axis translation plane with other planes below the multi-axis translation plane awaiting capture.

FIG. 9 depicts a multi-axis translation plane with preview planes above the multi-axis translation plane and preview planes below the multi-axis translation plane.

FIG. 10 depicts a user interface showing a “Render Details” selection screen according to an exemplary embodiment of the present disclosure.

FIG. 11 depicts a display screen displaying an exemplary three-dimensional model formed from rendered two-dimensional images.

FIG. 12 depicts a display screen displaying an exemplary three-dimensional model.

FIG. 13 depicts an exemplary display screen showing an exemplary three-dimensional model along with a Render Details screen.

### DETAILED DESCRIPTION

In some embodiments of the present disclosure, the operator may use a virtual controller or other input device to manipulate three-dimensional mesh. As used herein, the term “XR” is used to describe Virtual Reality, Augmented Reality, or Mixed Reality displays and associated software-based environments. As used herein, “mesh” is used to describe a three-dimensional object in a virtual world, including, but not limited to, systems, assemblies, subassemblies, cabling, piping, landscapes, avatars, molecules, proteins, ligands, or chemical compounds.

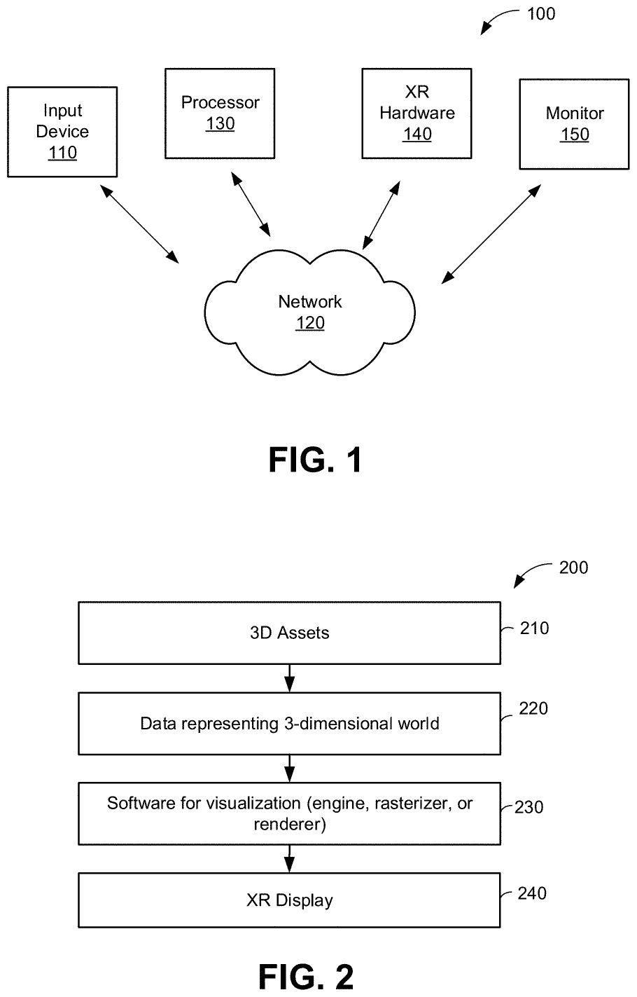

FIG. 1 depicts a system 100 for creating three-dimensional models capable of arbitrary manipulation on multiple axes, according to an exemplary embodiment of the present disclosure. The system 100 comprises an input device 110 communicating across a network 120 to a processor 130. The input device 110 may comprise, for example, a keyboard, a switch, a mouse, a joystick, a touch pad and/or other type of interface, which can be used to input data from a user (not shown) of the system 100. The network 120 may be a combination of hardware, software, or both. The system 100 further comprises XR hardware 140, which may be virtual or mixed reality hardware that can be used to visualize a three-dimensional world. The system 100 further comprises a video monitor 150 is used to display the three-dimensional data to the user. In operation of the system 100, the input device 110 receives input from the processor 130 and translates that input into an XR event or function call. The input device 110 allows a user to input data to the system 100, by translating user commands into computer commands.

FIG. 2 illustrates the relationship between three-dimensional assets 210, the data representing those assets 220, and the communication between that data and the software, which leads to the representation on the XR platform. The three-dimensional assets 210 may be any three-dimensional assets, which are any set of points that define geometry in three-dimensional space.

The data representing a three-dimensional world 220 is a procedural mesh that may be generated by importing three-dimensional models, images representing two-dimensional data, or other data converted into a three-dimensional format. The software for visualization 230 of the data representing a three-dimensional world 220 allows for the processor 130 (FIG. 1) to facilitate the visualization of the data representing a three-dimensional world 220 to be depicted as three-dimensional assets 210 in the XR display 240.

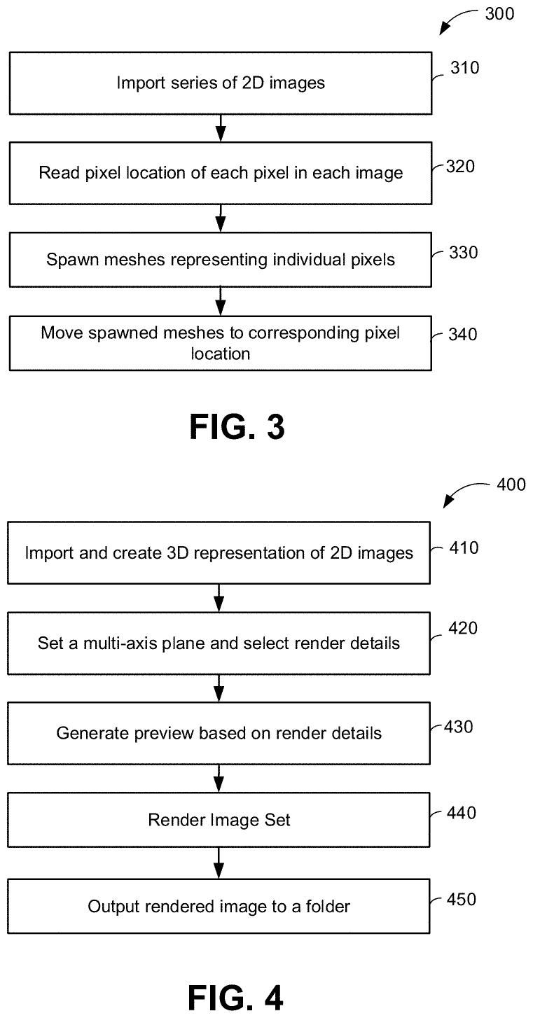

FIG. 3 depicts a method 300 of data importation and manipulation performed by the system, according to an exemplary embodiment of the present disclosure. In step 310 of the method 300, a series of two-dimensional images is imported. In this regard, a user uploads the series of two-dimensional images that will later be converted into a three-dimensional mesh. The importation step 310 can be done through a GUI interface, copying the files into a designated folder, or other methods. In step 320, the processor reads the location of each pixel in each image. In step 330, the processor spawns mesh representing each individual pixel. In step 350, the spawned meshes are moved to the corresponding pixel location using either a provided value or a user-determined threshold.

FIG. 4 depicts a method 400 for creating three-dimensional models capable of unlimited manipulation on arbitrary axes, according to an exemplary embodiment of the present disclosure. In step 410, the 2D images are imported and 3D representations created, per the method 300 of FIG. 3. In step 420, the user sets a multi-axis plane to render mesh and provides input to specify the render details. Specifically, the user may select the multi-axis plane and the image spacing. FIG. 12 illustrates a multi-axis plane 1220 being set by the user moving a virtual plane in 3D space.

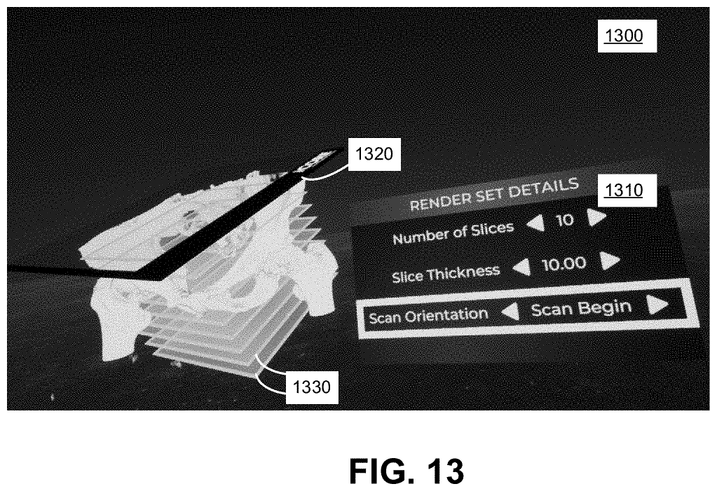

The user can also set the number of slices to render, slice thickness, and scan orientation. The multi-axis plane is set by moving a virtual plane in 3D space (See FIG. 12, 1220). In the embodiment illustrated in FIG. 13, a Render Details screen 1310 is used to set spacing options and the number of slices desired for the rendering. The spacing options are set based on user input and are incremented/decremented by a specific increment.

Referring to FIG. 4, in step 430 a preview is generated based upon render details selected by the user. FIG. 13 illustrates an exemplary preview screen 1300 showing a multi-axis plane 1320 that the user has set. The user can review the preview to make sure the alignment is what is desired before the images are rendered. As discussed further with respect to FIG. 13, the preview screen 1300 includes a plurality of preview planes 1330, each preview plane 1330 representing a slice in the rendering. In FIG. 13, the user requested ten (10) slices, and there are ten (10) preview planes 1330.

In step 440, if the user is satisfied with the preview, the user directs the system to render the image set with the specified input, and the image set is rendered. In step 450, the rendered image is output to a folder for further use by the user.

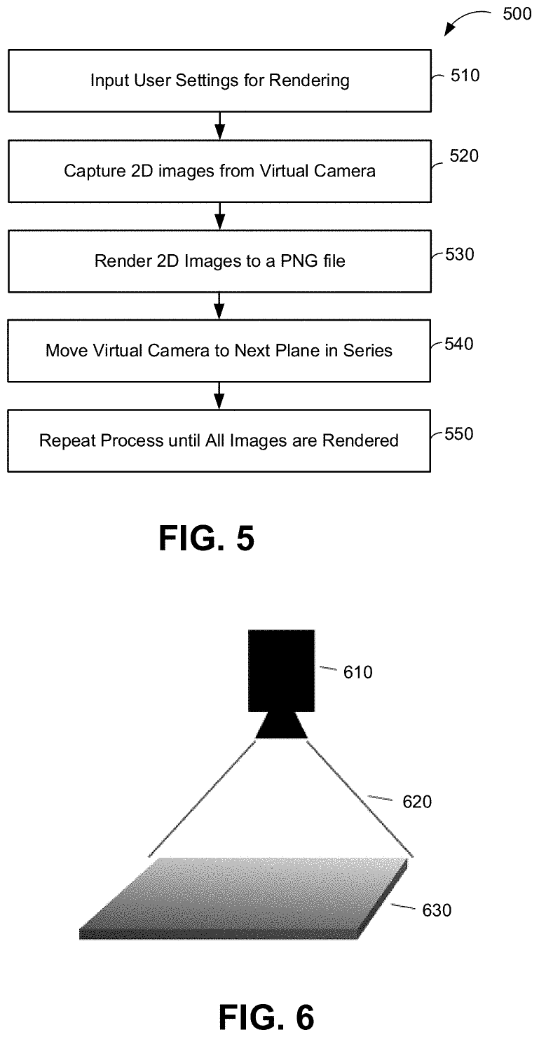

FIG. 5 depicts a method 500 of rendering images per step 440 in FIG. 4, according to an exemplary embodiment of the present disclosure. In step 510 of the method 500, the user provides input for the desired rendering. In step 520 of the method 500, 2D images are captured from a virtual camera. The virtual camera takes a picture at each of the preview plane's locations in virtual space, as further discussed herein. In step 530, the captured 2D images are rendered to a PNG (Portable Network Graphics) file. In step 540, the virtual camera is moved to the next plane in the series of preview planes or slices. In step 550, the steps 520 through 540 are repeated until all images are rendered.

FIG. 6 depicts a virtual camera 610 capturing a 2D image of a plane 630 with a field of view 620. The virtual camera 610 is further discussed with respect to FIG. 5. The plane 630 represents a slice of a rendered 3D model. FIG. 6 shows just one slice or plane 630.

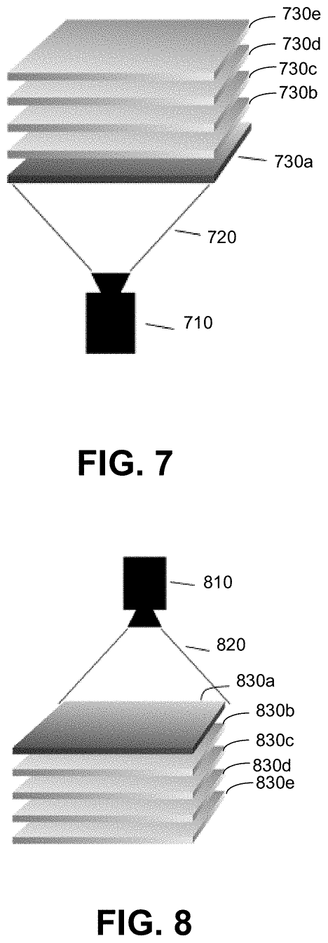

FIG. 7 depicts a virtual camera 710 capturing a 2D image of a plane 730a with a field of view 720. Other planes 730b-730d are above the plane 730a being captured. The plane 730a represents the multi axis translation plane and the planes 730b-730d represent the remaining preview planes or slices above the plane 730a. The virtual camera 710 first captures a 2D image of the plane 730a and them moves to the plane 730b, then to 730c, until all of the 2D images of the planes 730a-730d have been captured.

FIG. 8 depicts a virtual camera 810 capturing a 2D image 830a with a field of view 820. Other planes 830b-830d are below the plane 830a being captured. The plane 830a represents the multi axis translation plane and the planes 830b-830d represent the preview planes or slices below the plane 830a. The virtual camera 810 first captures a 2D image of the plane 830a and them moves to the plane 830b, then to 830c, until all of the 2D images of the planes 830a-830d have been captured. The order in which the images are captured, e.g., from bottom to top in FIG. 7 or from top to bottom in FIG. 8, affects the resultant image orientation. For example, the orientation of the camera may be either looking up from the bottom of the mesh or looking down from the top of the mesh.

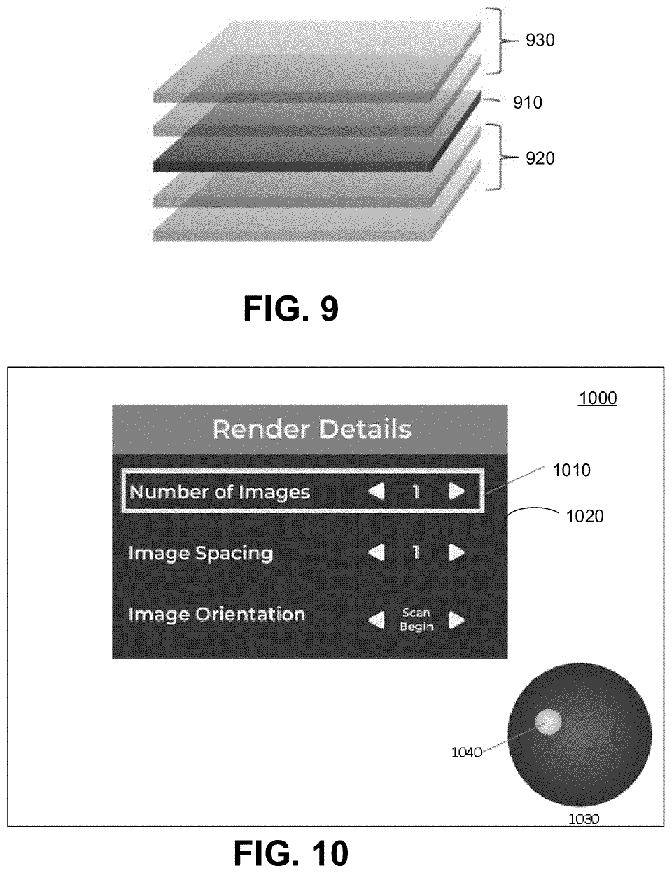

FIG. 9 depicts a multi-axis translation plane 910 with preview planes 930 above the multi-axis translation plane 910 and preview planes 920 below the multi-axis translation plane 910. This configuration illustrations a situation where a health care professional would like to set the multi-axis translation plane in the middle of the stack of images, with the preview planes extending from the middle. For example, the health care professional might want to see a little bit of the image before and after an area of interest.

FIG. 10 is a user interface 1000 (i.e., image screen) showing a “Render Details” screen 1020 that enables a user to select render options, as discussed above with respect to step 420 of FIG. 4. The user can select the number of 2D images to be rendered in box 1010 of the user interface 1000. The box 1010 also represents to the user that this is the current value being set. If the user wanted to set the image spacing, the user could indicate such by pressing the “down” key on a controller or other input device. A box would then appear around Image Spacing and the user would then use input to change Image Spacing.

The user can also select the spacing of the images and the image orientation. For the image orientation, the user can select between “scan begin,” “scan end,” and “scan center.” With “scan begin” selected, the virtual camera starts taking the images at the multi-axis translation plane and continues to the end of the stack of planes. With “scan end” selected, the virtual camera starts taking the images at the end of the stack of planes, and works back toward the multi-axis translation plane. With “scan center” selected, the virtual camera takes the images from the top down and the multi-axis translation plane is rendered in the middle of the set of images.

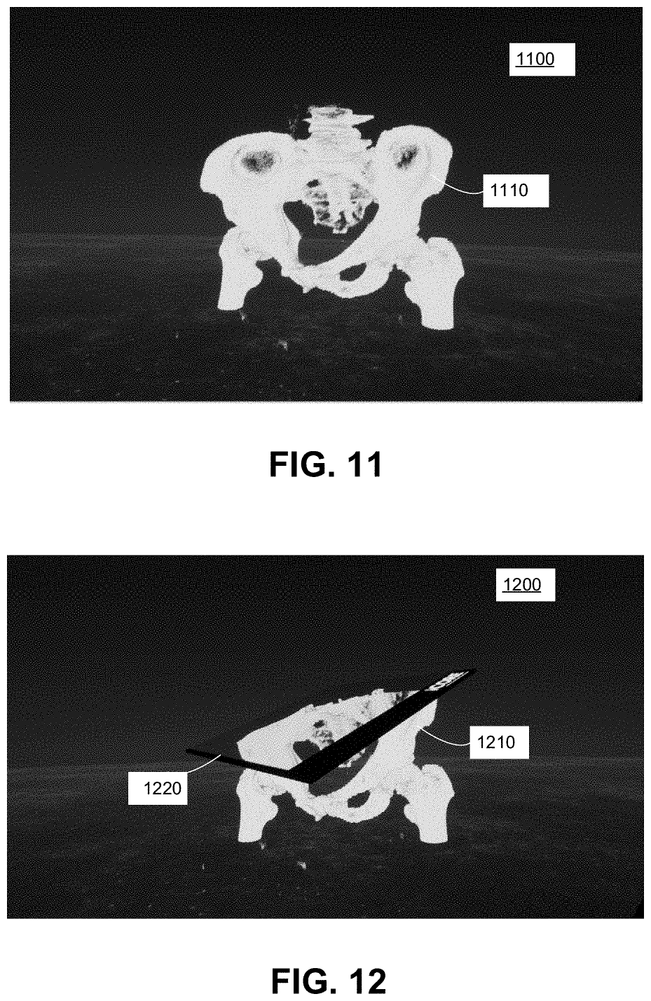

The user interface 1000 also displays a touchpad 1030 on a user input device 1040. The user makes its selections using the touchpad 1030 on the user input device 1040. FIG. 11 depicts a display screen 1100 displaying an exemplary 3D model 1110 formed from rendered 2D images using the method 300 of FIG. 3. The 3D model 1110 is of a human pelvis in this example.

FIG. 12 depicts a display screen 1200 displaying an exemplary 3D model 1210. In this example, the 3D model 1210 is a human pelvis. A multi-axis plane 1220 (discussed further in step 420 of FIG. 4) can be controlled by a user and moved in three-dimensions until the user has the plane 1220 in a desired position.

FIG. 13 illustrates an exemplary preview screen 1300 showing a multi-axis plane 1310 that the user has set. As discussed above with reference to FIG. 4, the user can review the preview to make sure the alignment is what is desired before the images are rendered. The preview screen 1300 includes a plurality of preview planes 1330, each preview plane 1320 representing a slice in the rendering. A Render Details screen 1310 is substantially similar to the screen 1020 of FIG. 10. In the example shown in FIG. 13, the user requested ten (10) slices, and there are ten (10) preview planes 1330 (or nine plus the multi-axis translation plane 1320).

What is claimed is:

1. A method for creating multi-axis three-dimensional models from two-dimensional images, the method comprising:
creating a three-dimensional model from a series of two-dimensional images;
displaying the three-dimensional model to a user in a virtual reality space;
generating a multi-axis translation plane within the virtual reality space, the multi-axis translation plane moveable in any direction by the user in virtual reality to intersect with the three-dimensional model, the multi-axis translation plane settable in a desired position by the user;
rendering an image set comprising two-dimensional images substantially parallel to the desired position of the multi-axis translation plane; and
outputting the rendered image set.

2. The method of claim 1, wherein the step of creating a three-dimensional model from a series of two-dimensional images comprises:
importing a series of two-dimensional images;
reading a pixel location of each pixel in each image; and
spawning meshes representing individual pixels to generate a three-dimensional model from the two-dimensional images.

3. The method of claim 1, wherein the step of rendering an image set comprising two-dimensional images substantially parallel to the desired position of the multi-axis translation plane further comprises generating a preview display after the user sets the desired position for the multi-axis translation plane, the preview display comprising the multi-axis translation plane and a plurality of slices of preview planes, the multi-axis translation plane and the preview planes spaced equidistantly from one another at a distance set by the user.

4. The method of claim 3, wherein the step of rendering an image set comprising two-dimensional images substantially parallel to the desired position of multi-axis translation plane further comprises capturing a two-dimensional image, by a virtual camera, of each of the multi-axis translation plane and the preview planes.

5. The method of claim 4, wherein the virtual camera captures the two dimensional images of the multi-axis translation plane and the preview planes in an order set by the user.

6. The method of claim 3, wherein the step of rendering an image set comprising two-dimensional images substantially parallel to the desired position of the multi-axis translation plane further comprises realigning, by the user, of the multi-axis translation plane after viewing the preview display and before the two-dimensional images are rendered.

7. The method of claim 3, wherein the plurality of slices of preview planes comprises a number of planes set by the user.

8. The method of claim 4, wherein the step of rendering an image set comprising two-dimensional images substantially parallel to the desired position of multi-axis translation plane further comprises rendering each two-dimensional image captured by the virtual camera to a PNG file.

9. The method of claim 8, wherein the step of outputting the rendered image set further comprises outputting PNG files to a folder.
